(19) United States
(12) Patent Application Publication
(10) Pub. No.: US 2014/0063300 A1
(43) Pub. Date: Mar. 6, 2014

(54) HIGH DYNAMIC RANGE IMAGING SYSTEMS HAVING CLEAR FILTER PIXEL ARRAYS

(71) Applicant: Aptina Imaging Corporation, George Town (KY)

(72) Inventors: Peng Lin, Pleasnton, CA (US); Marko Mlinar, Horjul (SI)

(73) Assignee: Aptina Imaging Corporation, George Town (KY)

(21) Appl. No.: 14/012,784

(22) Filed: Aug. 28, 2013

Related U.S. Application Data
(60) Provisional application No. 61/697,764, filed on Sep. 6, 2012.
(60) Provisional application No. 61/814,131, filed on Apr. 19, 2013.

(51) Int. Cl. H04N 5/355; H04N 9/04

(52) U.S. Cl. CPC H04N 5/35536; H04N 9/045
USPC 348/277; 348/302; 348/295

(57) ABSTRACT

Imaging systems may include an image sensor and processing circuitry. An image sensor may include a pixel array having rows and columns. The array may include short and long-exposure groups of pixels arranged in a zig-zag pattern. The short-exposure group may generate short-exposure pixel values in response to receiving control signals from control circuitry over a first line and the long-exposure group may generate long-exposure pixel values in response to receiving control signals from the control circuitry over a second line. The processing circuitry may generate zig-zag-based interleaved high-dynamic-range images using the long and short-exposure pixel values. If desired, the array may include short and long-exposure sets of pixels located in alternating single pixel rows. The processing circuitry may generate single-row-based interleaved high-dynamic-range images using pixel values generated by the short and long-exposure sets.

This application claims the benefit of provisional patent application No. 61/697,764, filed Sep. 6, 2012, and provisional patent application No. 61/814,131, filed Apr. 19, 2013, which are hereby incorporated by reference herein in their entireties.

### BACKGROUND

The present invention relates to imaging devices and, more particularly, to high-dynamic-range imaging systems.

Image sensors are commonly used in electronic devices such as cellular telephones, cameras, and computers to capture images. In a typical arrangement, an electronic device is provided with an image sensor having an array of image pixels and a corresponding lens. Some electronic devices use arrays of image sensors and arrays of corresponding lenses.

In certain applications, it may be desirable to capture high-dynamic range images. While highlight and shadow detail may be lost using a conventional image sensor, highlight and shadow detail may be retained using image sensors with high-dynamic-range imaging capabilities.

Common high-dynamic-range (HDR) imaging systems use multiple images that are captured by the image sensor, each image having a different exposure time. Captured short-exposure images may retain highlight detail while captured long-exposure images may retain shadow detail. In a typical device, image pixel values from short-exposure images and long-exposure images are selected to create an HDR image. Capturing multiple images can take an undesirable amount of time and/or memory.

In some devices, HDR images are generated by capturing a single interleaved long-exposure and short-exposure image in which alternating pairs of rows of pixels are exposed for alternating long and short-integration times. The long-exposure rows are used to generate an interpolated long-exposure image and the short-exposure rows are used to generate an interpolated short-exposure image. A high-dynamic-range image can then be generated from the interpolated images.

When capturing high-dynamic-range images using alternating pairs of rows of pixels that are exposed for alternating long and short-integration times, motion by the image sensor or in the imaged scene may cause artifacts such as motion artifacts and row temporal noise artifacts in the final high-dynamic-range image.

It would therefore be desirable to provide improved imaging systems for high-dynamic-range imaging.

### BRIEF DESCRIPTION OF THE DRAWINGS

FIG. 1 is a diagram of an illustrative imaging system in accordance with an embodiment of the present invention.

FIG. 2 is a diagram of an illustrative pixel array and associated row control circuitry for operating image pixels and column readout circuitry for reading out image data from the image pixels for generating zig-zag-based interleaved image frames in accordance with an embodiment of the present invention.

FIG. 3 is a diagram of an illustrative image sensor pixel in accordance with an embodiment of the present invention.

FIG. 4 is a diagram showing how illustrative first and second interpolated image frames may be generated from a zig-zag-based interleaved image frame during generation of a high-dynamic-range image in accordance with an embodiment of the present invention.

FIG. 5 is a diagram of an illustrative pixel unit cell in an image sensor pixel array having clear filter pixels in accordance with an embodiment of the present invention.

FIG. 6 is a diagram of an illustrative pixel array having clear filter image pixels, zig-zag patterned short-exposure pixel groups, and zig-zag patterned long-exposure pixel groups for generating zig-zag-based interleaved image frames in accordance with an embodiment of the present invention.

FIG. 7 is a diagram of illustrative pixel control paths that may each be connected to corresponding zig-zag patterned short-exposure pixel groups and zig-zag patterned long-exposure pixel groups for generating zig-zag-based interleaved image frames in accordance with an embodiment of the present invention.

FIG. 8 is a flow chart of illustrative steps that may be used by an image sensor for capturing a zig-zag-based interleaved image for generating high-dynamic-range images in accordance with an embodiment of the present invention.

FIG. 9 is a diagram of an illustrative pixel array and associated row control circuitry for operating image pixels in pixel rows and column readout circuitry for reading out image data from image pixels along column lines for generating single-row-based interleaved image frames in accordance with an embodiment of the present invention.

FIG. 10 is a diagram of an illustrative pixel array having clear filter image pixels and alternating single rows of short-exposure and long-exposure image pixels for generating single-row-based interleaved image frames for generating high-dynamic-range images in accordance with an embodiment of the present invention.

FIG. 11 is a diagram of an illustrative pixel array having clear filter image pixels, blue pixel columns, red pixel columns, and alternating single rows of short-exposure and long-exposure image pixels for generating single-row-based interleaved image frames for generating high-dynamic-range images in accordance with an embodiment of the present invention.

FIG. 12 is a block diagram of a processor system employing the image sensor of FIGS. 1-11 in accordance with an embodiment of the present invention.

### DETAILED DESCRIPTION

Electronic devices such as digital cameras, computers, cellular telephones, and other electronic devices include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels) arranged in pixel rows and pixel columns. Image sensors may include control circuitry such as row control circuitry for operating the image pixels on a row-by-row bases and column readout circuitry for reading out image signals corresponding to electric charge generated by the photosensitive elements along column lines coupled to the pixel columns.

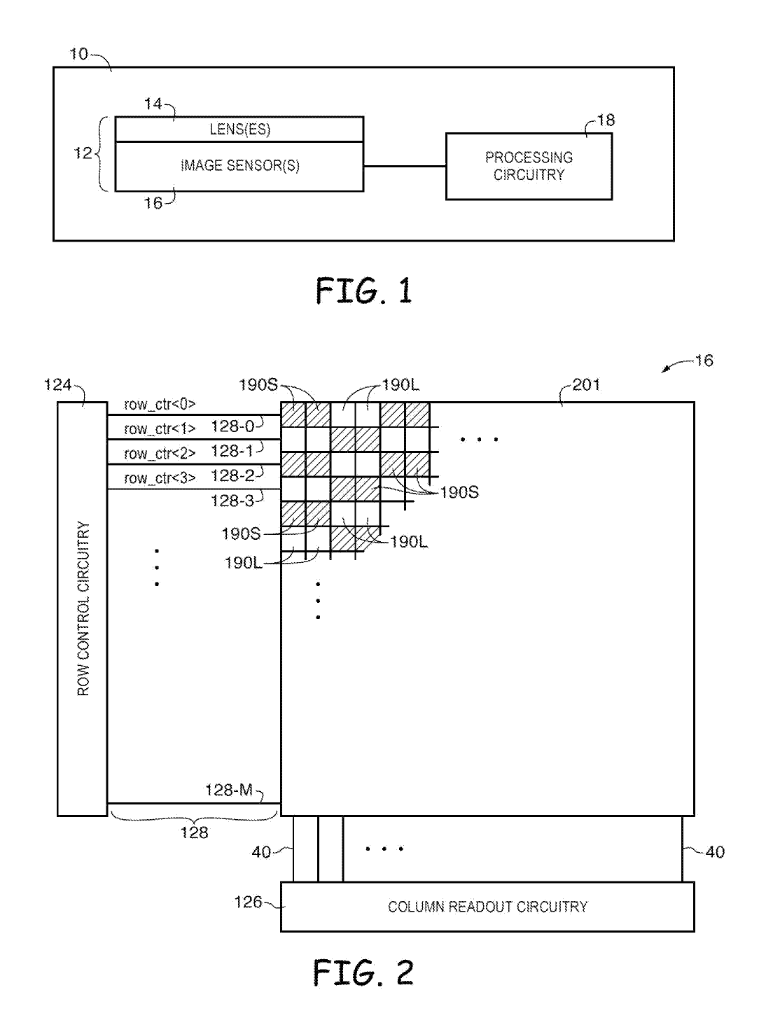

FIG. 1 is a diagram of an illustrative electronic device with an image sensor for capturing images. Electronic device 10 of FIG. 1 may be a portable electronic device such as a camera, a cellular telephone, a video camera, or other imaging device that captures digital image data. Device 10 may include a camera module such as camera module 12 coupled to control circuitry such as processing circuitry 18. Camera module 12 may be used to convert incoming light into digital image data. Camera module 12 may include one or more lenses 14 and one or more corresponding image sensors 16. During image capture operations, light from a scene may be focused onto each image sensor 16 using a respective lens 14. Lenses 14 and image sensors 16 may be mounted in a common package and may provide image data to processing circuitry 18.

Processing circuitry 18 may include one or more integrated circuits (e.g., image processing circuits, microprocessors, storage devices such as random-access memory and non-volatile memory, etc.) and may be implemented using components that are separate from image sensor 16 and/or that form part of image sensor 16 (e.g., circuits that form part of an integrated circuit that controls or reads pixel signals from image pixels in an image pixel array on image sensor 16 or an integrated circuit within image sensor 16). Image data that has been captured by image sensor 16 may be processed and stored using processing circuitry 18. Processed image data may, if desired, be provided to external equipment (e.g., a computer or other device) using wired and/or wireless communications paths coupled to processing circuitry 18.

The dynamic range of an image may be defined as the luminance ratio of the brightest element in a given scene to the darkest element the given scene. Typically, cameras and other imaging devices capture images having a dynamic range that is smaller than that of real-world scenes. High-dynamic-range (HDR) imaging systems are therefore often used to capture representative images of scenes that have regions with high contrast, such as scenes that have portions in bright sunlight and portions in dark shadows.

An image may be considered an HDR image if it has been generated using imaging processes or software processing designed to increase dynamic range. Image sensor 16 may be a staggered-exposure based interleaved high-dynamic range image sensor (sometimes referred to herein as a “zig-zag” based interleaved high-dynamic range image sensor). A zig-zag-based interleaved high-dynamic-range (ZiHDR) image sensor may generate high-dynamic-range images using an adjacent row-based interleaved image capture process. An adjacent row-based interleaved image capture process may be performed using an image pixel array with adjacent pixel rows that each have both long and short-integration image pixels.

For example, a first pixel row in a ZiHDR image sensor may include both long-exposure and short-exposure pixels. A second pixel row that is adjacent to the first pixel row in the ZiHDR sensor (e.g., a second pixel row immediately above or below the first pixel row) may also include both long-exposure and short-exposure pixels. If desired, the long-exposure pixels of the second pixel row may be adjacent to the short-exposure pixels of the first pixel row and the short-exposure pixels of the second pixel row may be adjacent to the long-exposure pixels of the first pixel row. For example, the short-exposure pixels of the first pixel row may be formed in a first set of pixel columns and the long-exposure pixels of the first pixel row may be formed in a second set of pixel columns that is different from the first set of pixel columns. The short-exposure pixels of the second pixel row may be formed in the second set of pixel columns and the long-exposure pixels of the second pixel row may be formed in the first set of pixel columns. In this way, the short-integration pixels may be formed in a first zig-zag (staggered) pattern across the first and second pixel rows and the long-integration pixels may be formed in a second zig-zag pattern across the first and second pixel rows that is interleaved with the first zig-zag pattern.

In other words, two adjacent pixel rows in the ZiHDR image sensor may include a group of short-exposure pixels arranged in a zig-zag pattern and a group of long-exposure pixels arranged in a zig-zag pattern. The group of short-exposure pixel values arranged in a zig-zag pattern may be interleaved with the group of long-exposure pixels arranged in a zig-zag pattern (e.g., the long-exposure pixel zig-zag pattern may be interleaved with the short-exposure pixel zig-zag pattern). Each pair of adjacent pixel rows in the pixel array may include a respective group of short-exposure pixels arranged in a zig-zag pattern and a respective group of long-exposure pixels arranged in a zig-zag pattern (e.g., the zig-zag patterns of short and long-exposure pixel values may be repeated throughout the array).

The long-exposure image pixels may be configured to generate long-exposure image pixel values during a long-integration exposure time (sometimes referred to herein as a long-integration time or long-exposure time). The short-integration image pixels may be configured to generate short-exposure image pixel values during a short-integration exposure time (sometimes referred to herein as a short-integration time or short-exposure time). Interleaved long-exposure and short-exposure image pixel values from image pixels in adjacent pairs of pixel rows may be readout simultaneously along column lines coupled to the image pixels. Interleaved long-exposure and short-exposure image pixel values from all active pixel rows may be used to form a zig-zag-based interleaved image.

The long-exposure and short-exposure image pixel values in each zig-zag-based interleaved image may be interpolated to form interpolated long-exposure and short-exposure values. A long-exposure image and a short-exposure image may be generated using the long-exposure and the short-exposure pixels values from the interleaved image frame and the interpolated long-exposure and short-exposure image pixel values. The long-exposure image and the short-exposure image may be combined to produce a composite ZiHDR image which is able to represent the brightly lit as well as the dark portions of the image.

As shown in FIG. 2, image sensor 16 may include a pixel array 201 containing image sensor pixels such as long-exposure image pixels 190L and short-exposure image pixels 190S. Each pixel row in array 201 may include both long-exposure image pixels 190L and short-exposure image pixels 190S. The long-exposure image pixels 190L from a particular pixel row may be staggered relative to the long-exposure image pixels 190L from pixel rows immediately above and/or below that pixel row in array 201. For example, each pixel row may include long-exposure image pixels 190L that are formed adjacent to the short-exposure pixels 190S from the adjacent pixel rows (e.g., long-exposure pixel values 190L and short-exposure pixel values 190S may form a zig-zag pattern across pixel array 201).

Image sensor 16 may include row control circuitry 124 for supplying pixel control signals row_ctr to pixel array 201 over row control paths 128 (e.g., row control circuitry 124 may supply row control signals row_ctr<0> to a first row of array 201 over path 128-0, may supply row control signals row_ctr<1> to a second row of array 201 over path 128-1, etc.). Row control signals row_ctr may, for example, include one or more reset signals, one or more charge transfer signals, row-select signals and other read control signals to array 201 over row control paths 128. Conductive lines such as column lines 40 may be coupled to each of the columns of pixels in array 201.

Long-exposure pixels 190L from each pair of adjacent pixel rows in array 201 may sometimes be referred to as long-exposure pixel groups and short-exposure pixels 190S from each pair of adjacent pixel rows in array 201 may sometimes be referred to as short-exposure pixel groups. For example, long-exposure pixels 190L in the first to rows of array 201 may form a first long-exposure pixel group, long-exposure pixels 190L in the third and fourth rows of array 201 may form a second long-exposure pixel group, short-exposure pixels 190S in the first to rows of array 201 may form a first short-exposure pixel group, short-exposure pixels 190S in the third and fourth rows of array 201 may form a second short-exposure pixel group, short-exposure pixels 190S in the fifth and sixth rows of array 201 may form a third short-exposure pixel group, etc.

If desired, the pixels in each pixel group may each be coupled to a single row control path 128 that is associated with that pixel group. For example, each pixel in a given pixel group may be coupled to a single row control path 128 and may receive a single address pointer over row control path 128. As an example, the first group of short-exposure pixels 190S located in the first two rows of array 201 may be coupled to first row control path 128-0 for receiving row control signals row_ctr<0>, the first group of long-exposure pixels 190L located in the first two rows of array 201 may be coupled to second row control path 128-1 for receiving row control signals row_ctr<1>, the second group of short-exposure pixels 190S located in the third and fourth rows of array 201 may be coupled to third row control path 128-2 for receiving row control signals row_ctr<2>, the second group of long-exposure pixels 190L located in the third and fourth rows of array 201 may be coupled to fourth row control path 128-3 for receiving row control signals row_ctr<3>, etc. During pixel readout operations, each pixel group in array 201 may be selected by row control circuitry 124 and image signals gathered by that group of pixels can be read out along respective column output lines 40 to column readout circuitry 126.

Column readout circuitry 126 may include sample-and-hold circuitry, amplifier circuitry, analog-to-digital conversion circuitry, column randomizing circuitry, column bias circuitry or other suitable circuitry for supplying bias voltages to pixel columns and for reading out image signals from pixel column in array 201.

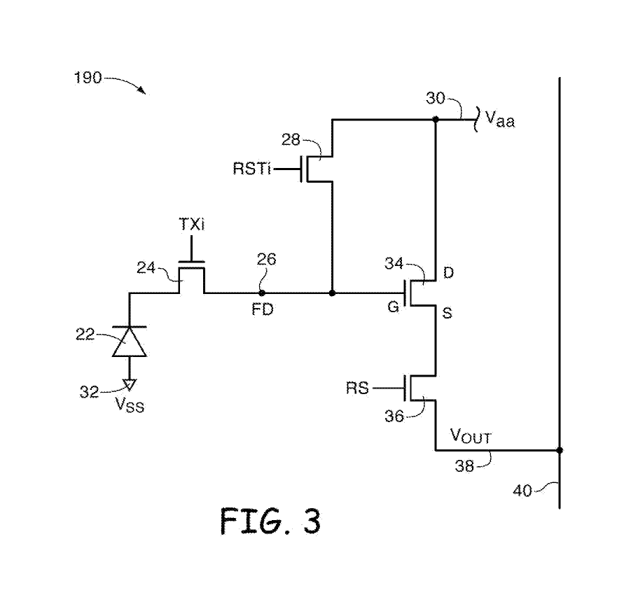

Circuitry in an illustrative one of image sensor pixels 190 in sensor array 201 is shown in FIG. 3. As shown in FIG. 3, pixel 190 includes a photosensitive element such as photodiode 22. A positive power supply voltage (e.g., voltage Vaa) may be supplied at positive power supply terminal 30. A ground power supply voltage (e.g., Vss) may be supplied at ground terminal 32 and ground terminal 218. Incoming light is collected by photodiode 22 after passing through a color filter structure. Photodiode 22 converts the light to electrical charge.

Before an image is acquired, reset control signal RSTi may be asserted. This turns on reset transistor 28 and resets charge storage node 26 (also referred to as floating diffusion FD) to Vaa. The reset control signal RSTi may then be deasserted to turn off reset transistor 28. After the reset process is complete, transfer control signal TXi may be asserted to turn on transfer transistor (transfer gate) 24. When transfer transistor 24 is turned on, the charge that has been generated by photodiode 22 in response to incoming light is transferred to charge storage node 26. Charge storage node 26 may be implemented using a region of doped semiconductor (e.g., a doped silicon region formed in a silicon substrate by ion implantation, impurity diffusion, or other doping techniques).

The doped semiconductor region (i.e., the floating diffusion FD) exhibits a capacitance that can be used to store the charge that has been transferred from photodiode 22. The signal associated with the stored charge on node 26 is conveyed to row-select transistor 36 by source-follower transistor 34.

When it is desired to read out the value of the stored charge (i.e., the value of the stored charge that is represented by the signal at the source S of transistor 34), row-select control signal RS can be asserted. When signal RS is asserted, transistor 36 turns on and a corresponding signal Vout that is representative of the magnitude of the charge on charge storage node 26 is produced on output path 38. In a typical configuration, there are numerous rows and columns of pixels such as pixel 190 in array 12. A vertical conductive path such as path 40 can be associated with each column of pixels. When signal RS is asserted for a given pixel group in array 201, path 40 can be used to route signal Vout from that pixel group to readout circuitry such as column readout circuitry 126 (see FIG. 2).

Reset control signal RSTi and transfer control signal TXi for each image pixel 190 in array 201 may be one of two or more available reset control or transfer control signals. For example, short-exposure pixels 190S may receive a reset control signal RST1 (or a transfer control signal TX1). Long-exposure pixels 190L may receive a separate reset control signal RST2 (or a separate transfer control signal TX2). In this way, image pixels 190 in a common pixel row may be used to capture interleaved long-exposure and short-exposure image pixel values that may be combined into a ZiHDR image.

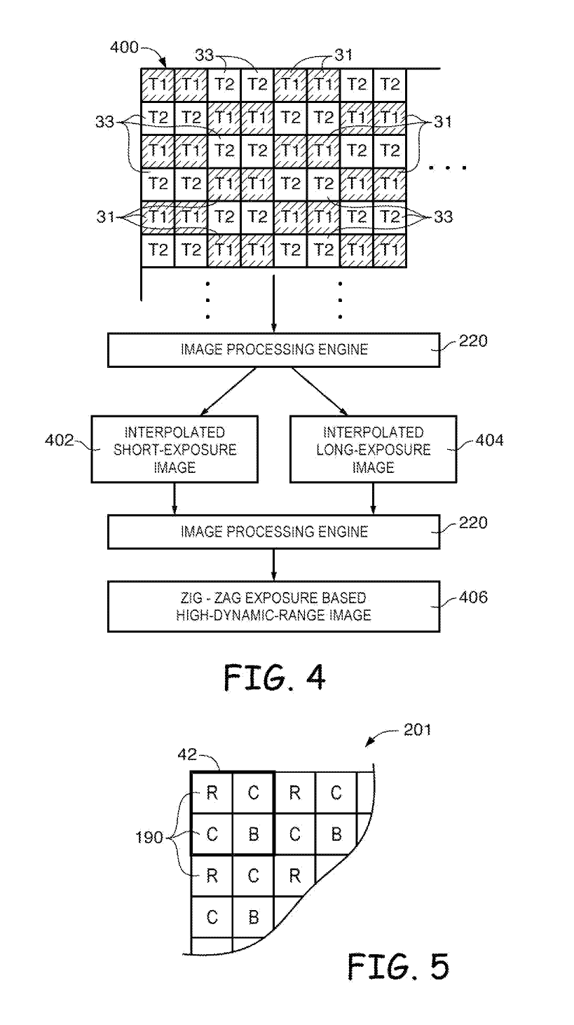

FIG. 4 is a flow diagram showing how a zig-zag based interleaved image can be processed to form a ZiHDR image. As shown in FIG. 4, zig-zag based interleaved image 400 may include pixel values 31 that have been captured using a first exposure time period T1 such as a short-exposure time period by groups of short-exposure pixels 190S in array 201 and image 400 may include pixel values 33 that have been captured using a second exposure time period T2 such as a long-exposure time period by groups of long-exposure pixels 190L in array 201 (see FIG. 2).

Processing circuitry such as image processing engine 220 (e.g., software or hardware based image processing software on image sensor 16, formed as a portion of processing circuitry 18, or other processing circuitry associated with device 10) may be used to generate interpolated short-exposure image 402 and interpolated long-exposure image 404 using the pixel values of zig-zag based interleaved image 400. Interpolated short-exposure image 402 may be formed using short-exposure pixel values 31 (sometimes referred to as short-integration pixel values) of image 400 and interpolated pixel values based on those short-exposure pixel values in pixel locations at which image 400 includes long-exposure image pixel values 33. Interpolated long-exposure image 404 may be formed using long-exposure pixel values 33 (sometimes referred to as long-integration pixel values) of image 400 and interpolated pixel values based on those long-exposure pixel values in pixel locations at which image 400 includes short-exposure image pixel values 31. In this way, full short-exposure and long-exposure images may be generated using a single column-based interleaved image.

Image processing engine 220 may then be used to combine the pixel values of interpolated long-exposure image 404 and interpolated short-exposure image 402 to form zig-zag-based interleaved high-dynamic-range (ZiHDR) image 406. For example, pixel values from interpolated short-exposure image 402 may be selected for ZiHDR image 406 in relatively bright portions of image 406 and pixel values from interpolated long-exposure image 404 may be selected for ZiHDR image 406 in relatively dim portions of image 406.

Image sensor pixels 190 may be covered by a color filter array that includes color filter elements over some or all of image pixels 190. Color filter elements for image sensor pixels 26 may be red color filter elements (e.g., photoresistive material that passes red light while reflecting and/or absorbing other colors of light), blue color filter elements (e.g., photoresistive material that passes blue light while reflecting and/or absorbing other colors of light), green color filter elements (e.g., photoresistive material that passes green light while reflecting and/or absorbing other colors of light), clear color filter elements (e.g., transparent material that passes red, blue and green light) or other color filter elements. If desired, some or all of image pixels 190 may be provided without any color filter elements. Image pixels that are free of color filter material and image pixels that are provided with clear color filters may be referred to herein as clear pixels, white pixels, clear image pixels, or white image pixels. Clear image pixels 190 may have a natural sensitivity defined by the material that forms the transparent color filter and/or the material that forms the image sensor pixel (e.g., silicon). The sensitivity of clear image pixels 190 may, if desired, be adjusted for better color reproduction and/or noise characteristics through use of light absorbers such as pigments. Pixel array 201 having clear image pixels 190 may sometimes be referred to herein as clear filter pixel array 201.

Image sensor pixels are often provided with a color filter array which allows a single image sensor to sample red, green, and blue (RGB) light using corresponding red, green, and blue image sensor pixels arranged in a Bayer mosaic pattern. The Bayer mosaic pattern consists of a repeating unit cell of two-by-two image pixels, with two green image pixels diagonally opposite one another and adjacent to a red image pixel diagonally opposite to a blue image pixel. However, limitations of signal to noise ratio (SNR) that are associated with the Bayer Mosaic pattern make it difficult to reduce the size of image sensors such as image sensor 16. It may therefore be desirable to be able to provide image sensors with an improved means of capturing images.

In one suitable example that is sometimes discussed herein as an example, the green pixels in a Bayer pattern are replaced by clear image pixels, as shown in FIG. 5. As shown in FIG. 5, a repeating two-pixel by two-pixel unit cell 42 of image pixels 190 may be formed from two clear image pixels (C) that are diagonally opposite one another and adjacent to a red (R) image pixel that is diagonally opposite to a blue (B) image pixel. Unit cell 42 may be repeated across pixel array 201 to form a mosaic of red, clear, and blue image pixels 190. In this way, red image pixels 190 in array 21 may generate red pixel values in response to red light, blue image pixels 190 may generate blue pixel values in response to blue light, and clear image pixels 190 may generate clear pixel values in response to clear light.

The unit cell 42 of FIG. 5 is merely illustrative. If desired, unit cells 42 may include any suitable combination of two, three, four, or more than four image pixels. If desired, any color image pixels may be formed adjacent to the diagonally opposing clear image pixels 26 in unit cell 24 (e.g., the red image pixels in unit cell 24 may be replaced with blue image pixels, the blue image pixels in unit cell 24 may be replaced with red image pixels, the red image pixels in unit cell 24 may be replaced with yellow image pixels, the blue image pixels in unit cell 24 may be replaced with magenta image pixels, etc.).

Clear image pixels 190 can help increase the signal-to-noise ratio (SNR) of image signals captured by image sensor 16 by gathering additional light in comparison with image pixels having a narrower color filter (e.g., a filter that transmits light over a subset of the visible light spectrum), such as green image pixels. Clear image pixels 190 may particularly improve SNR in low light conditions in which the SNR can sometimes limit the image quality of images. Image signals generated by clear filter pixel array 201 may be converted to red, green, and blue image signals to be compatible with circuitry and software that is used to drive most image displays (e.g., display screens, monitors, etc.). This conversion generally involves the modification of captured image signals using a color correction matrix (CCM).

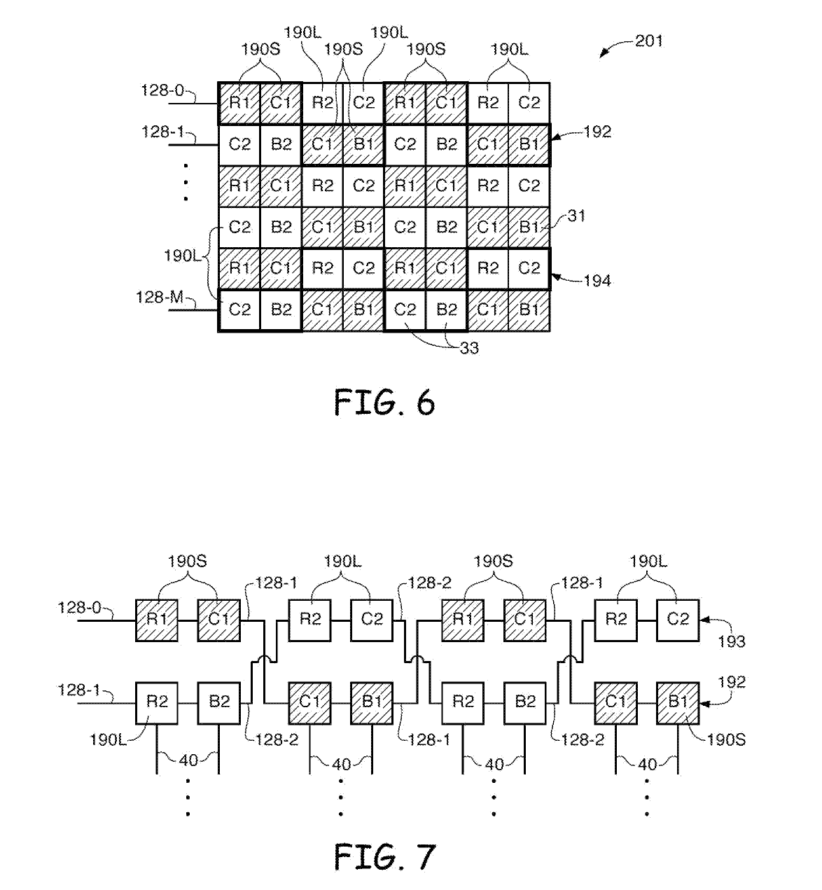

FIG. 6 is an illustrative diagram of pixel array 201 having repeating unit cells of color filter elements such as unit cell 42 of FIG. 5. As shown in FIG. 6, clear filter pixel array 201 may include long-exposure red image pixels R2 configured to generate red pixel values during long-exposure time period T2, long-exposure blue image pixels B2 configured to generate blue pixel values during long-exposure time period T2, long-exposure clear image pixels C2 configured to generate long-exposure clear pixel values during long-exposure time period T2, short-exposure red image pixels R1 configured to generate red pixel values during short-exposure time period T1, short-exposure blue image pixels B1 configured to generate short-exposure blue pixel values during short-exposure time period T1, and short-exposure clear image pixels C1 configured to generate short-exposure clear pixel values during short-exposure time period T1 (e.g., long-exposure image pixels 190L may include red long-exposure image pixels R2, blue long-exposure image pixels B2, and clear long-exposure image pixels C2, whereas short-exposure image pixels 190S may include red short-exposure image pixels R1, blue short-exposure image pixels B1, and clear short-exposure image pixels C1).

Each pair of pixel rows in clear filter pixel array 201 may include an associated long-exposure image pixel group and an associated short-exposure image pixel group. In the example of FIG. 6, the short-exposure image pixel group associated with the first two rows of array 201 is labeled 192 and the long-exposure image pixel group associated with the fifth and sixth rows of array 201 is labeled 194. In general, each pair of pixel rows in array 201 includes both an associated long-exposure pixel group and an associated short-exposure pixel group. The pixels 190L in each long-exposure pixel group of array 201, such as long-exposure pixel group 194, may be connected to an associated row control line 128. The pixels 190S in each short-exposure pixel group in array 201, such as short-exposure pixel group 192, may be connected via an associated row control line 128. In the example of FIG. 6, each of the pixels in short-integration pixel group 192 may be coupled to row control line 128-0. The pixels in short-integration pixel group 192 may be addressed by a single address pointer associated with row control line 128-0. Each of the pixels in long-integration group 194 may be coupled to row control line 128-M (e.g., there may be M+1 rows in array 201 corresponding to M+1 different row control lines 128). The pixels in long-integration group 194 may be addressed by a single row pointer associated with row control line 128-M. Short-exposure pixel groups in array 201 may receive control signals over the associated row control lines 128 that direct the short-exposure pixels to gather image signals during short-exposure time period T1 and long-exposure pixel groups in array 201 may receive control signals over the associated row control lines 128 that direct the long-exposure pixels to gather image signals during long-exposure time period T2. For example, short-exposure pixel group 192 may receive reset control signal RST1 and/or transfer control signal TX1 (see FIG. 3) for performing charge integration during short-exposure time period T1, whereas long-exposure pixel group 194 may receive reset control signal RST2 and/or transfer control signal TX2 for performing charge integration during long-exposure time period T2.

In the example of FIG. 6, row control paths corresponding to odd numbered rows in array 201 may convey control signals for capturing image data during short-exposure time period T1 whereas row control paths corresponding to even numbered rows in array 201 may convey control signals for capturing image data during long-exposure time period T2. However, this example is merely illustrative. If desired, row control paths corresponding to odd numbered rows in array 201 may provide control signals for capturing image data during long-exposure time period T2 and row control paths corresponding to even numbered rows in array 201 may provide control signals for capturing image data during short-exposure time period T1. In this scenario, short-exposure pixels 190S in array 201 of FIG. 6 may be replaced with long-exposure pixels and long-exposure pixels 190L in array 201 may be replaced with short-exposure pixels.

FIG. 7 is a diagram showing how the image pixels 190 in each pixel group may be coupled to a corresponding row control path 128. As shown in FIG. 7, short-exposure pixel group 192 from the first two rows of pixel array 201 (see FIG. 6) may be coupled to first row control path 128-0 whereas a long-exposure pixel group 193 from the first two rows of array 201 may be coupled to second row control path 128-1. Each pixel 190S in short-exposure pixel group 192 may receive a single address pointer associated with first row control path 128-0. Each pixel 190S in short-exposure pixel group 192 may receive row control signals from path 128-0 that direct short-exposure pixel group 192 to generate short-exposure pixel values 31 (see FIG. 4) during short-exposure time period T1. Each pixel 190S in short-exposure pixel group 192 may be coupled to a column line 40 for reading out image signals from that pixel. In the example of FIG. 7, each short-exposure pixel 190S in short-exposure pixel group 192 may be coupled to a common reset control line, a common row-select control line, a common transfer control line, and/or other common row control signal lines such as row control path 128-1.

Short-exposure pixel group 192 may, for example, include a first set of image pixels 190S located in the first row of array 201 and may include a second set of image pixels 190S located in the second row of array 201. Long-exposure pixel group 193 may include a third set of image pixels 190L located in the first row of array 201 and may include a fourth set of image pixels 190L located in the second row of array 201. The first set of image pixels 190S may be interleaved with the third set of image pixels 190L and the second set of image pixels 190S may be interleaved with the fourth set of image pixels 190L.

Long-exposure pixel group 193 may be coupled to second row control path 128-1 (e.g., long-exposure pixel group 193 may be include the long-exposure pixels 190L in the first two rows of pixel array 201 of FIG. 6). Each pixel 190L in long-exposure pixel group 193 may receive a single address pointer associated with second row control path 128-1. Each pixel 190L in long-exposure pixel group 193 may receive row control signals via path 128-1 that direct long-exposure pixel group 193 to generate long-exposure pixel values 33 (see FIG. 4) during long-exposure time period T2. Each pixel 190L in long-exposure pixel group 193 may be coupled to a column line 40 for reading out image signals from that pixel. In the example of FIG. 7, each long-exposure pixel 190L in long-exposure pixel group 193 may be coupled to a common rest control line, a common row-select control line, a common transfer control line, and/or other common row control signal lines such as row control path 128-1.

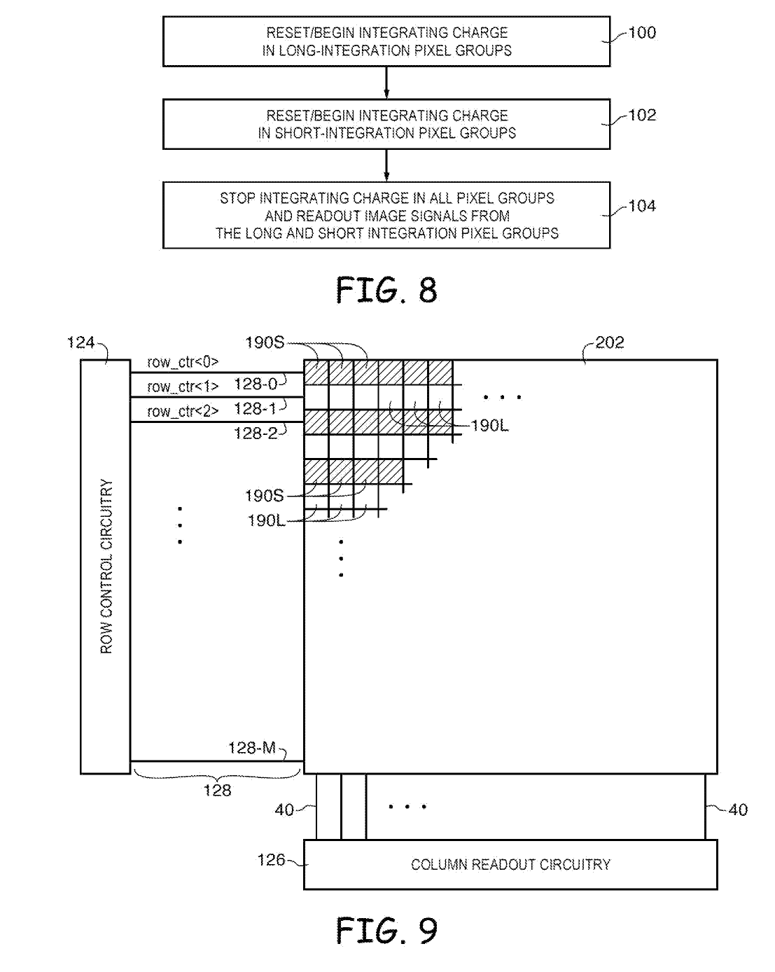

Illustrative steps that may be used by image sensor 16 for capturing zig-zag based interleaved image 400 (FIG. 4) using image pixel array 201 having short-exposure pixel groups and long-exposure pixel groups arranged in zig-zag patterns are shown in FIG. 8.

At step 100, long-exposure pixel groups such as long-exposure pixel group 193 in clear filter may be reset and may subsequently begin integrating charge in response to received image light.

At step 102, short-exposure pixel groups in array 201 such as short-exposure pixel group 192 of FIG. 7 may be reset and may begin integrating charge in response to received image light (e.g., after the long-exposure pixel groups in array 201 have begun integrating charge).

At step 104, long-exposure pixel groups and short-exposure pixel groups in array 201 may stop integrating charge (e.g., image sensor 16 may use a rear-curtain exposure synchronization). In this way, long-exposure pixel values may be gathered by long-exposure pixel groups in array 201 during long integration time period T2 and short-exposure pixel values may be gathered by short-exposure pixel groups in array 201 during short integration time period T1 (e.g., time period T2 may be the time period between performing steps 100 and 104 and time period T1 may be the time period between performing steps 102 and 104).

Long-exposure pixels 190L and short-exposure pixels 190S may be readout. Reading out the pixels may include providing a common row-select signal RS to the long-integration pixel groups and the short-integration pixel groups in array 201 to allow image signals based on the integrated and transferred charges to be transmitted along column lines to column readout circuitry. As an example, array 201 may be readout using a rolling shutter readout algorithm.

Image sensor 16 may use the image signals read out from clear filter pixel array 201 to generate zig-zag based interleaved image 400 for generating zig-zag based interleaved high-dynamic range 406 of FIG. 4. By gathering zig-zag based interleaved images such as image 400 of FIG. 4 using clear filter pixel array 201, image sensor 16 may be provided with improved sampling resolution relative to image sensors that capture a single interleaved long-exposure and short-exposure image in which alternating pairs of rows of pixels are exposed for alternating long and short-integration times (e.g., by providing short and long-exposures in a zig-zag pattern as shown by interleaved image 400 of FIG. 4, the final zig-zag based interleaved high-dynamic-range image 406 may have improved sampling resolution that is free from motion artifacts).

If desired, row control circuitry 124 or other processing circuitry such as processing circuitry 18 of FIG. 2 may set the short-exposure time period T1 and long-exposure time period T2 with which pixel array 201 generates zig-zag based interleaved image 400. If desired, image sensor 16 may provide control signals to the long-exposure pixel groups and the short-exposure pixel groups that instruct all pixels in clear filter pixel array 201 to gather image signals during a single integration time (e.g., the long-exposure pixel groups and the short-exposure pixel groups in array 201 may stop integrating charge at the same time or may integrate charge during the same time period). For example, image sensor 16 may set short-exposure time period T1 equal to long-exposure time period T2. In this scenario, image sensor 16 may disable HDR imaging operations by setting short-exposure time period T1 equal to long-exposure time period T2, and an image having a single exposure time may be read out from array 201. In this way, image sensor 16 may use pixel array 201 as both a full-resolution image sensor and as a zig-zag based interleaved high-dynamic-range image sensor during normal operation of device 10.

In another suitable arrangement, image sensor 16 of FIG. 1 may be provided with a pixel array having alternating single rows of long and short-exposure pixels for generating single-row-based interleaved images in which alternating single pixel rows may be used to generate short and long-integration pixel values. If desired, image sensor 16 may use the single-row-based interleaved images to generate high-dynamic range images.

FIG. 9 is an illustrative diagram that shows how image sensor 16 may include a pixel array 202 for performing single-row interleaved high dynamic range imaging operations. As shown in FIG. 9, image sensor 16 may include pixel array 202 having alternating single rows of long-exposure pixels and short-exposure pixels (e.g., pixels from alternating rows of pixel array 202 may be provided with pixel control signals that instruct the pixels to gather image signals during a long-exposure time or during a short-exposure time).

As shown in FIG. 9, array 202 may include alternating rows of long-exposure pixels 190L and short-exposure pixels 190S. In the example of FIG. 9, the odd-numbered rows of array 201 include short-exposure pixels 190S for gathering image signals during short-exposure time period T1 and the even-numbered rows of array 201 include long-exposure pixels 190L for gathering image signals during long-exposure time period T2. This is merely illustrative. If desired, the even-numbered rows of array 201 may include long-exposure image pixels 190L and the odd-numbered rows of array 201 may include short-exposure image pixels 190S.

In this scenario, pixel array 202 may generate a single-row-based interleaved image in which single rows of short-exposure pixel values are interleaved with single rows of long-exposure pixel values. Pixel array 202 may be provided with a color filter array having color filter elements of a given number of colors. In order to ensure that each row in array 201 generates pixel values of each color for the associated exposure time, pixel array 202 may be provided with a color filter array in which each row of the color filter array includes at least one color filter element of each color in the array. For example, if a color filter array for pixel array 202 has clear, blue, and red color filter elements, each row of pixel array 202 may include clear, blue, and red pixels.

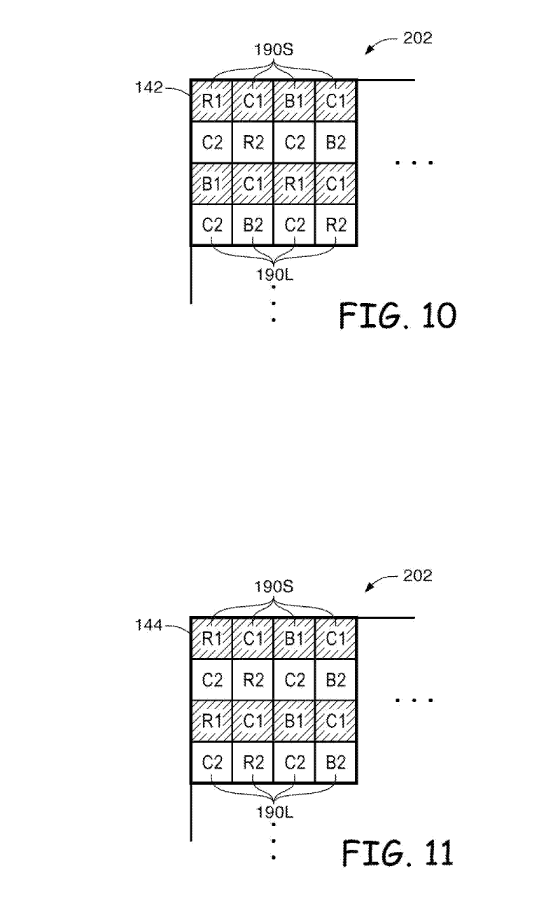

FIG. 10 is an illustrative diagram of a color filter unit cell that may be formed on pixel array 202 for performing single-row-based interleaved high dynamic range imaging operations. As shown in FIG. 10, pixel array 202 may include a repeating four-pixel by four-pixel unit cell 142 of image pixels 190. Each row of unit cell 142 may include clear, red, and blue pixels. For example, the odd-numbered rows of unit cell 142 may include short-exposure clear pixels (C1), short-exposure red pixels (R1), and short-exposure blue pixels (B1), whereas the even-numbered rows of unit cell 142 may include long-exposure clear pixels (C2), long-exposure red pixels (R2), and long-exposure blue pixels (B2).

In the example of FIG. 10, the first two columns of the first two rows of unit cell 142 may include a short-exposure clear pixel formed diagonally opposite to a long-exposure clear pixel and adjacent to a short-exposure red pixel formed diagonally opposite to a long-exposure red pixel. The third and fourth columns of the first two rows of unit cell 142 may include a short-exposure clear pixel formed diagonally opposite to a long-exposure clear pixel and adjacent to a short-exposure blue pixel formed diagonally opposite to a long-exposure blue pixel. The first two columns of the third and fourth rows of unit cell 142 may include a short-exposure clear pixel formed diagonally opposite to a long-exposure clear pixel and adjacent to a short-exposure blue pixel formed diagonally opposite to a long-exposure blue pixel. The third and fourth columns of the third and fourth rows of unit cell 142 may include a short-exposure clear pixel formed diagonally opposite to a long-exposure clear pixel and adjacent to a short-exposure red pixel formed diagonally opposite to a long-exposure red pixel. Each row of array 202 may generate pixel values associated with each color of the color filter array. In this way, image sensor 16 may read out short-exposure pixel values of each color from each of the odd-numbered rows in array 202 and may read out long-exposure pixel values of each color from each of the even-numbered rows in array 202.

FIG. 11 is an illustrative diagram of another suitable unit cell that may be formed on pixel array 202 for performing single-row interleaved high dynamic range imaging operations. As shown in FIG. 11, pixel array 202 may include a repeating four-pixel by four-pixel unit cell 144 of image pixels 190. Each row of unit cell 144 may include clear, red, and blue pixels. For example, the odd-numbered rows of unit cell 142 may include short-exposure clear pixels (C1), short-exposure red pixels (R1), and short-exposure blue pixels (B1), whereas the even-numbered rows of unit cell 142 may include long-exposure clear pixels (C2), long-exposure red pixels (R2), and long-exposure blue pixels (B2). In the example of FIG. 11, the first two columns of image pixels 190 in unit cell 144 may include short-exposure clear pixels, long-exposure clear pixels, short-exposure red pixels, and long-exposure red pixels. The third and fourth columns of image pixels 190 in unit cell 144 may include short-exposure clear pixels, long-exposure clear pixels, short-exposure blue pixels, and long-exposure blue pixels. In particular, the first two columns of the first two rows of unit cell 144 may include a short-exposure clear pixel formed diagonally opposite to a long-exposure clear pixel and adjacent to a short-exposure red pixel formed diagonally opposite to a long-exposure red pixel. The third and fourth columns of the first two rows of unit cell 144 may include a short-exposure clear pixel formed diagonally opposite to a long-exposure clear pixel and adjacent to a short-exposure blue pixel formed diagonally opposite to a long-exposure blue pixel. The first two columns of the third and fourth rows of unit cell 144 may include a short-exposure clear pixel formed diagonally opposite to a long-exposure clear pixel and adjacent to a short-exposure red pixel formed diagonally opposite to a long-exposure red pixel. The third and fourth columns of the third and fourth rows of unit cell 144 may include a short-exposure clear pixel formed diagonally opposite to a long-exposure clear pixel and adjacent to a short-exposure blue pixel formed diagonally opposite to a long-exposure blue pixel.

In this way, image sensor 16 may gather pixel values of each color from each row of array 202 while performing high-dynamic-range imaging operations. The examples of FIGS. 9 and 10 are merely illustrative. If desired, the clear pixels in array 202 may be replaced with green pixels. If desired, the red and blue pixels in array 202 may be replaced with pixels of any desired colors.

The pixel values generated by array 202 may be passed to imager processing circuitry such as image processing engine 220 of FIG. 4 and may be used to generate a single-row-based interleaved image. Image processing engine 220 may generate interpolated short-exposure images and interpolated long-exposure images based on the single-row-based interleaved image and may generate an interleaved high-dynamic range image based on the interpolated images (e.g., a single-row-based interleaved high-dynamic-range image). The high-dynamic range image generated by processing engine 220 using the single-row-based interleaved image of alternating short and long-exposure pixel values generated by array 202 may have improved sampling resolution relative to image sensors that capture a interleaved images in which alternating pairs of pixel rows are exposed for alternating long and short-integration times (e.g., because both short and long-exposure pixel values are generated for each pair of pixel rows in array 202).

If desired, pixel arrays such as pixel array 201 of FIG. 2 and pixel array 202 of FIG. 9 may be used to generate monochrome (e.g., black and white) images. If desired, image sensor 16 having pixel array 201 and/or pixel array 202 may be implemented in a surveillance system, bar code scanner system, business card scanner system, or any other desired imaging system that performs monochrome imaging operations.

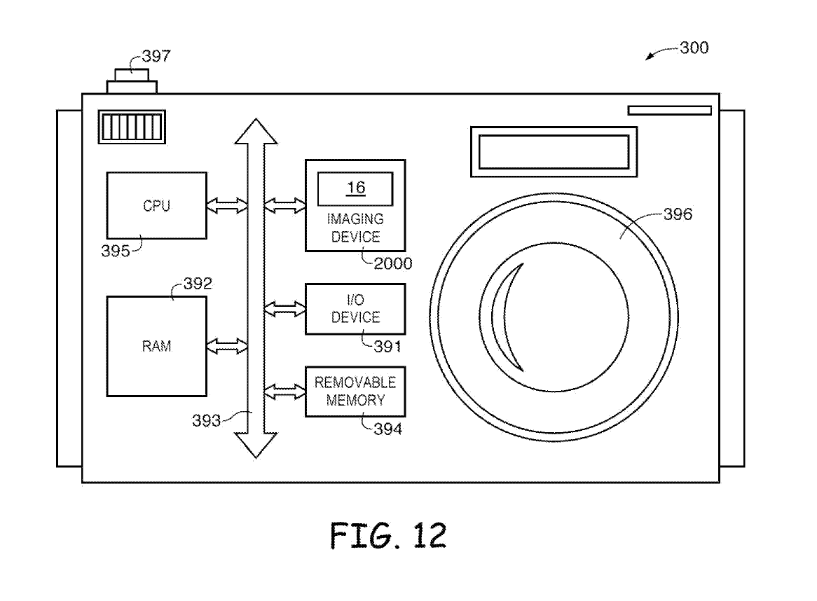

FIG. 12 shows in simplified form a typical processor system 300, such as a digital camera, which includes an imaging device such as imaging device 200 (e.g., an imaging device 200 such as device 10 of FIG. 1 configured to generate zig-zag based interleaved high-dynamic-range images and/or single row based interleaved high-dynamic range images as described above in connection with FIGS. 1-11). Processor system 300 is exemplary of a system having digital circuits that could include imaging device 200. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

Processor system 300, which may be a digital still or video camera system, may include a lens such as lens 396 for focusing an image onto a pixel array such as pixel array 201 and/or pixel array 202 when shutter release button 397 is pressed. Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Various embodiments have been described illustrating systems and methods for generating zig-zag based interleaved HDR images and single-row-based interleaved HDR images of a scene using a camera module having an image sensor and processing circuitry.

An image sensor may include an array of image pixels arranged in pixel rows and pixel columns. The array may include a short-exposure group of image pixels located in first and second pixel rows of the array and a long-exposure group of image pixels located in the first and second pixel rows. Each image pixel in the short-exposure pixel group may generate short-exposure pixel values in response to receiving first control signals from pixel control circuitry over a first pixel control line. Each image pixel in the long-exposure pixel group may generate long-exposure pixel values in response to receiving second control signals from the pixel control circuitry over a second pixel control line (e.g., the pixel control circuitry may instruct each image pixel in the short-exposure group through the first control line to generate the short-integration pixel values may instruct each image pixel in the long-exposure group through the second control line to generate the long-integration pixel values). The long-exposure pixel values and the short-exposure pixel values may be combined to generate a zig-zag-based interleaved image frame.

If desired, the short-exposure and long-exposure groups of image pixels may be arranged in a zig-zag pattern on the array. For example, the short-exposure group of image pixels may include a first set of image pixels located in the first pixel row and a second set of image pixels located in the second pixel row, whereas the long-exposure group of image pixels may include a third set of image pixels located in the first pixel row and a fourth set of image pixels located in the second pixel row. The first set of image pixels from the short-exposure group may be interleaved with the third set of image pixels from the long-exposure group and the second set of image pixels from the short-exposure group may be interleaved with the fourth set of image pixels from the long-exposure group. The first, second, third, and fourth sets of image pixels may each include clear image pixels having clear color filter elements.

If desired, column readout circuitry may read out the short-exposure pixel values and the long-exposure pixel values from the first and fourth sets of image pixels over a first conductive column line that is coupled to the first and fourth sets of image pixels. The column readout circuitry may read out the short-exposure pixel values and the long-exposure pixel values from the second and third sets of image pixels over a second conductive column line that is coupled to the second and third sets of image pixels.

The image sensor may include processing circuitry. The processing circuitry may generate an interpolated short-exposure image based on the short-exposure pixel values and an interpolated long-exposure image based on the long-exposure pixel values. The processing circuitry may generate a high-dynamic-range image based on the interpolated short-exposure image and the interpolated long-exposure image.

If desired, the pixel array may include first, second, and third consecutive rows of image pixels each having at least two clear image pixels. The pixel control circuitry may instruct each image pixel in the first and third rows of image pixels to generate short-integration pixel values may instruct each image pixel in the second row of image pixels to generate long-integration pixel values. The processing circuitry may generate an interpolated short-integration image based on the short-integration pixel values and an interpolated long-integration image based on the long-integration pixel values. The processing circuitry may generate an interleaved high-dynamic-range image (e.g., a single-row-based interleaved high-dynamic-range image) based on the interpolated short-integration image and the interpolated long-integration image.

The imaging system with a clear filter pixel array and processing circuitry and the associated techniques for generating zig-zag-based and single-row-based interleaved high-dynamic-range images may be implemented in a system that also includes a central processing unit, memory, input-output circuitry, and an imaging device that further includes a pixel array and a data converting circuit.

The foregoing is merely illustrative of the principles of this invention and various modifications can be made by those skilled in the art without departing from the scope and spirit of the invention. The foregoing embodiments may be implemented individually or in any combination.

What is claimed is:

1. An imaging system having an array of image pixels arranged in pixel rows and pixel columns, the imaging system comprising:
a first group of image pixels located in first and second pixel rows of the array;
a second group of image pixels located in the first and second pixel rows of the array, wherein the second group of image pixels is different from the first group of image pixels;
a first control line coupled to the first group of image pixels;
a second control line coupled to the second group of image pixels; and
pixel control circuitry, wherein each image pixel in the first group is configured to generate short-exposure pixel values in response to first control signals received from the pixel control circuitry over the first control line and wherein each image pixel in the second group is configured to generate long-exposure pixel values in response to second control signals received from the pixel control circuitry over the second control line.

2. The imaging system defined in claim 1, further comprising:
a conductive column line coupled to each pixel column; and
column readout circuitry coupled to the pixel columns through the conductive column lines, wherein the column readout circuitry is configured to read out the short-exposure pixel values from the first group of image pixels and configured to read out the long-exposure pixel values from the second group of image pixels.

3. The imaging system defined in claim 1, wherein the first group of image pixels comprises a first set of image pixels located in the first pixel row and a second set of image pixels located in the second pixel row, wherein the second group of image pixels comprises a third set of image pixels located in the first pixel row and a fourth set of image pixels located in the second pixel row, wherein the first set of image pixels is interleaved with the third set of image pixels, and wherein the second set of image pixels is interleaved with the fourth set of image pixels.

4. The imaging system defined in claim 3, wherein the first and fourth sets of image pixels are located in a first set of pixel columns of the array.

5. The imaging system defined in claim 4, wherein the second and third sets of image pixels are located in a second set of pixel columns of the array that is different from the first set of pixel columns.

6. The imaging system defined in claim 5, further comprising:
a first conductive column line coupled to the first and fourth sets of image pixels;
a second conductive column line coupled to the second and third sets of image pixels; and
column readout circuitry, wherein the column readout circuitry is coupled to the first and fourth sets of image pixels through the first conductive column line and wherein the column readout circuitry is coupled to the second and third sets of image pixels through the second conductive column line.

7. The imaging system defined in claim 6, wherein the first and second groups of image pixels in the array are arranged in a zig-zag pattern.

8. The imaging system defined in claim 3, further comprising:
an image processing engine configured to generate an interpolated short-exposure image based on the short-exposure pixel values and an interpolated long-exposure image based on the long-exposure pixel values.

9. The imaging system defined in claim 8, wherein the image processing engine is further configured to generate a high-dynamic-range image based on the interpolated short-exposure image and the interpolated long-exposure image.

10. The imaging system defined in claim 3, wherein the first, second, third, and fourth sets of image pixels each include clear image pixels having clear color filter elements.

11. The imaging system defined in claim 10, wherein the first and third sets of image pixels further comprise red image pixels having red color filter elements and wherein the second and fourth sets of image pixels further comprise blue image pixels having blue color filter elements.

12. The imaging system defined in claim 1, wherein each image pixel in the first group is configured to generate the short-exposure pixel values during a first integration time period in response to receiving the first control signals from the pixel control circuitry over the first control line and wherein each image pixel in the second group is configured to generate the long-exposure pixel values during a second integration time period that is longer than the first time period in response to receiving the second control signals from the pixel control circuitry over the second control line.

13. An image sensor having an array of image pixels arranged in pixel rows and pixel columns, wherein the array of image pixels comprises first, second, and third consecutive pixel rows, the image sensor comprising:
a first set of image pixels located in the first pixel row;
a second set of image pixels located in the second pixel row;
a third set of image pixels located in the third pixel row, wherein the first, second, and third sets of image pixels each include at least two clear image pixels; and
pixel control circuitry, wherein the pixel control circuitry is configured to instruct each image pixel in the first and third sets of image pixels to generate short-integration pixel values and wherein the pixel control circuitry is configured to instruct each image pixel in the second set of image pixels to generate long-integration pixel values.

14. The image sensor defined in claim 13, wherein the second pixel row is located immediately below the first pixel row in the array and wherein the third pixel row is located immediately below the second pixel row in the array.

15. The image sensor defined in claim 14, further comprising:
processing circuitry, wherein the processing circuitry is configured to generate an interpolated short-integration image based on the short-integration pixel values and wherein the processing circuitry is configured to generate an interpolated long-integration image based on the long-integration pixel values.

16. The image sensor defined in claim 15, wherein the processing circuitry is further configured to generate an interleaved high-dynamic-range image based on the interpolated short-integration image and the interpolated long-integration image.

17. The image sensor defined in claim 16, wherein the first and third sets of image pixels are configured to generate the short-integration pixel values in three color channels, wherein the second set of image pixels is configured to generate the long-integration pixel values in the three color channels, and wherein the three color channels includes a clear color channel.

18. The image sensor defined in claim 17, wherein the first set of image pixels includes a first blue image pixel, wherein the third set of image pixels includes a second blue image pixel, wherein the second set of image pixels includes a given clear image pixel, and wherein the given clear image pixel is located immediately below the first blue image pixel and immediately above the second blue image pixel in the array of image pixels.

19. The image sensor defined in claim 17, wherein the first set of image pixels includes a given blue image pixel, wherein the third set of image pixels includes a given red image pixel, wherein the second set of image pixels includes a given clear image pixel, and wherein the given clear image pixel is located immediately below the given blue image pixel and immediately above the given red image pixel in the array of image pixels.

20. A system, comprising:
a central processing unit;
memory;
input-output circuitry; and
an imaging device, wherein the imaging device comprises:
an array of image sensor pixels having pixel rows and columns, wherein the array of image sensor pixels include a first group of image pixels located in first and second pixel rows and a second group of image pixels located in the first and second pixel rows, wherein the second group of image pixels is different from the first group of image pixels;
a lens that focuses an image on the array of image sensor pixels;
a first control line coupled to the first group of image pixels;
a second control line coupled to the second group of image pixels; and
pixel control circuitry, wherein the pixel control circuitry is configured to instruct each image pixel in the first group through the first control line to generate short-integration pixel values and wherein the pixel control circuitry is configured to instruct each image pixel in the second group through the second control line to generate long-integration pixel values.

21. The system defined in claim 20, wherein the first group of image pixels is configured to generate the short-integration pixel values in three color channels, wherein the second group of image pixels is configured to generate the long-integration pixel values in the three color channels, and wherein the three color channels includes a clear color channel.

22. The system defined in claim 21, further comprising:
an image processing engine, wherein the image processing engine is configured to generate an interpolated short-integration image using the short-integration pixel values and an interpolated long-integration image using the long-integration pixel values, and wherein the image processing engine is configured to generate a high-dynamic-range image based on the interpolated short-integration image and the interpolated long-integration image.

23. The system defined in claim 22, wherein the first group of image pixels comprises a first set of image pixels located in the first pixel row and a second set of image pixels located in the second pixel row, wherein the second group of image pixels comprises a third set of image pixels located in the first pixel row and a fourth set of image pixels located in the second pixel row, wherein the first set of image pixels is interleaved with the third set of image pixels, wherein the second set of image pixels is interleaved with the fourth set of image pixels, and wherein the first, second, third, and fourth sets of image pixels each include clear image pixels having clear color filter elements.
